(19) United States
(12) Patent Application Publication
(10) Pub. No.: US 2015/0027577 A1
(43) Pub. Date: Jan. 29, 2015

(54) APPARATUS AND METHOD FOR SUPPORTING A REHABILITATION PIPE

(71) Applicant: Shonan Gosei-Jushi Seisakusho K.K., Kanagawa-ken (JP)

(72) Inventors: Takao KAMIYAMA, Kanagawa-ken (JP); Masaki TAKEYAMA, Nagano-ken (JP)

(21) Appl. No.: 14/337,564

(22) Filed: Jul. 22, 2014

(30) Foreign Application Priority Data
Jul. 26, 2013 (JP) 2013-155217

(51) Int. Cl. F16L 55/164; F16L 55/163

(52) U.S. Cl. CPC F16L 55/164; F16L 55/163
USPC 138/97

(57) ABSTRACT

A rehabilitation pipe is assembled inside an existing pipe using integrally formed plastic segments each comprising an inner surface plate, side and end plates. The segments are in part or all divided in the pipe-length direction to provide a variable-width segment comprising two segment halves that are moved relative to each other in the pipe-length direction to make the width of the segment in the pipe-length direction variable. A filler is injected into a space between the rehabilitation pipe and the existing pipe to provide a composite pipe. A falsework temporarily supports the rehabilitation pipe inside the existing pipe until the filler hardens. A shape-holing member is disposed circumferentially in part or all over the inner surface of the rehabilitation pipe so as to be in contact with the inner surface plate of the variable-width segment. A support member directly or indirectly supports the shape-holding member.

### BACKGROUND OF THE INVENTION

1. Field of the Invention

The present invention relates to an apparatus and method for a rehabilitation pipe adapted for use in constructing a rehabilitation pipe for repairing pipeline facilities in which the rehabilitation pipe is assembled by linking segments in the circumferential direction and in the pipe-length direction. The segments each comprise an inner surface plate constituting an inner circumferential surface, and side plates and end plates provided upright on peripheral edges of the inner surface plate, these plates being formed integrally from a plastic material.

2. Description of the Related Art

In cases in which a sewage pipe or another pipeline buried underground has deteriorated through aging, a pipe lining method has been proposed and practiced in which a lining is provided to the inner circumferential surface thereof to repair the pipeline without excavating it from the ground.

JP-A 2010-43731 discloses a method using segments each comprising an inner surface plate constituting an inner circumferential surface, side plates and end plates provided upright on the peripheral edges of the inner surface plate, these plates being integrally formed from a plastic material. The segments are linked in the circumferential direction to provide pipe units, which are then linked in the pipe-length direction to construct a rehabilitation pipe for repairing a pipeline. In the method, some of the segments are divided in the pipe-length direction into two segment halves, which are moved relative to each other in the pipe-length direction to make the width of the segment in the pipe-length direction variable.

After assembling the rehabilitation pipe inside an existing pipe using the segments, a filler is injected between the existing pipe and the rehabilitation pipe. Until the filler becomes hardened, the rehabilitation pipe is supported by a falsework. FIGS. 14a and 14b show an example of a falsework for supporting a rehabilitation pipe. Segments 210 each of which corresponds to one-fifth the circumference of a pipe are linked in the circumferential direction to provide a pipe unit 213. The pip units are then linked in the pipe-length direction to construct a rehabilitation pipe 202 inside an existing pipe 201. Each of the segments 210 is divided into two segment halves in the pipe-length direction. The two segment halves 211, 212 are placed against each other so as to overlap at one end. The overlapping portions of the segment halves are made variable to vary the width of the segment 210.

A spacer 205 is used to adjust the space between the existing pipe 201 and the rehabilitation pipe 202. A wale 206 that is disposed in the pipe-length direction so as to be in contact with the inner surface of the rehabilitation pipe 202 is supported by a support member 203 that is adjustable in length by jack bases 204 connected at ends thereto.

### SUMMARY OF THE INVENTION

In cases in which variable-width segments as described in JP-A 2010-43731 are used, such a falsework as shown in FIGS. 14a and 14b causes a problem in that the filler is likely to leak at locations, for example, at a location A indicated in FIG. 14b among the overlapping portions of the variable-width segments 211, 212 that are not pressed by the wales 206.

It is therefore an object of the present invention to provide an apparatus and method for supporting a rehabilitation pipe being capable of preventing a filler from leaking when constructing a rehabilitation pipe inside an existing pipe using variable-width segments.

The present invention provides an apparatus and method for supporting a rehabilitation pipe inside an existing pipe since a filler is injected into a space between the rehabilitation pipe and the existing pipe until the filler hardens. The rehabilitation pipe is assembled using integrally formed plastic segments each comprising an inner surface plate, and side and end plates provided upright on a peripheral edge of the inner surface plate. The segments are in part or all divided in the pipe-length direction to provide a variable-width segment comprising two segment halves that are moved relative to each other in the pipe-length direction to make the width of the segment in the pipe-length direction variable. A shape-holing member is disposed circumferentially in part or all over the inner surface of the rehabilitation pipe so as to be in contact with the inner surface plate of the variable-width segment. A support member is provided for directly or indirectly supporting the shape-holding member.

According to the present invention, the shape-holding member is pressed circumferentially against the inner surface plate of the variable-width segment, thereby pressing one segment half against the other segment half. This allows the space between the two segment halves to be shortened, preventing the filler injected from leaking from the segment halves.

### BRIEF DESCRIPTION OF THE DRAWINGS

FIG. 1 is a cross-sectional view showing the structure of a rehabilitation pipe;

FIG. 2 is a perspective view showing the structure of a pipe unit;

FIG. 3 is a cross-sectional view showing the structure of a rehabilitation pipe;

FIG. 4 is a perspective view showing the structure of a segment;

FIG. 5a is a plan view showing the structure of an end plate of the segment;

FIG. 5b and 5c are cross-sectional views each showing a variable-width segment;

FIG. 6 is a cross-sectional view showing a variable-width segment;

FIG. 7 is an illustrative view showing a state in which pipe units are linked to install a rehabilitation pipe;

FIGS. 8a and 8b are illustrative views each showing a falsework when using a variable-width segment;

FIGS. 9a through 9d are cross-sectional views each showing a variable-width segment and a falsework;

FIG. 10 is a cross-sectional view showing the shape of another shape-holding member;

FIG. 11 is a cross-sectional view showing a rehabilitation pipe with earthquake resistance improved;

FIGS. 12a and 12b are cross-sectional views each showing the seams of an existing pipe and a variable-width segment;

FIG. 13 is a cross-sectional view showing a falsework for a rehabilitation pipe with earthquake resistance improved; and

FIGS. 14a and 14b are illustrative views each showing a conventional falsework.

### DESCRIPTION OF THE PREFERRED EMBODIMENTS

The present invention will now be described with references to embodiments illustrated in the accompanying drawings. The present invention is suitable for rehabilitating or repairing large-diameter existing pipes such as sewage pipes, water supply pipes, tunnels, and agricultural irrigation channels. In the present embodiment, the rehabilitation pipes are described as having a circular cross-section profile orthogonal to the pipe-length direction. However, it shall be apparent that the present invention can be applied to a rehabilitation pipe having a square or another non-circular cross-section.

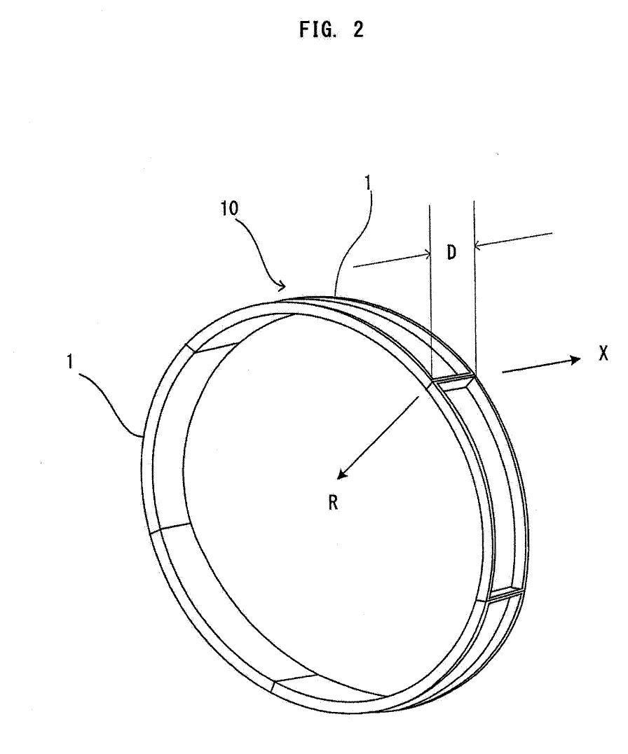

In the present specifications, the pipe-length direction refers to the direction indicated by arrow X extending in the longitudinal direction of a pipe unit 10 in FIG. 2, the radial direction refers to the direction indicated by the radial arrow R pointing towards the center axis of the pipe unit 10, and the circumferential direction refers to the direction of the circumference of the circle forming the pipe unit 10.

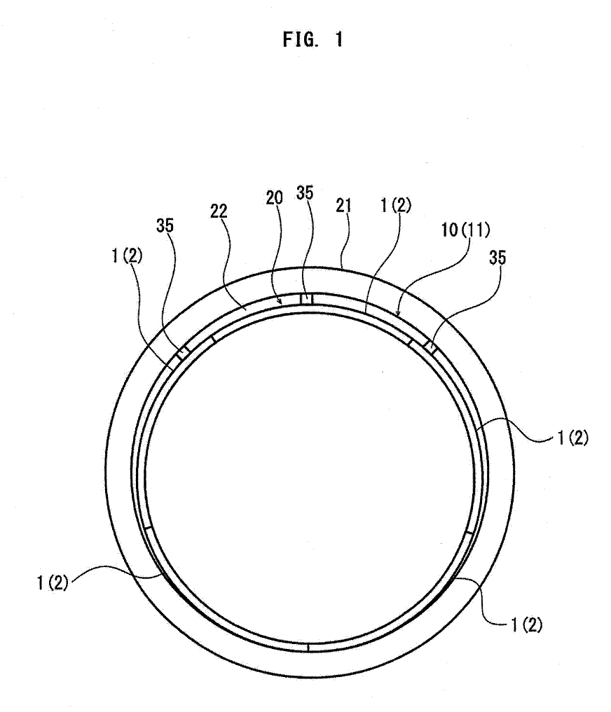

According to one embodiment of the present invention, a pipe unit 10 and a variable-width pipe unit 11 are linked in the pipe-length direction to construct a rehabilitation pipe 20 inside an existing pipe 21 having a circular cross-section as shown in FIG. 1. A filler such as mortar or grout is injected into a space between the existing pipe 21 and the rehabilitation pipe 20.

As shown in FIG. 2, the pipe unit 10 is assembled by linking segments 1 in the circumferential direction. One segment corresponds to a block obtained by dividing the cross section of the rehabilitation pipe 20 into a plurality of (for example, five) portions. The variable-width pipe unit 11 has a structure similar to that of the pipe unit 10 in FIG. 2 and are assembled using variable-width segments with their width in the pipe-length direction made variable, as will be described later.

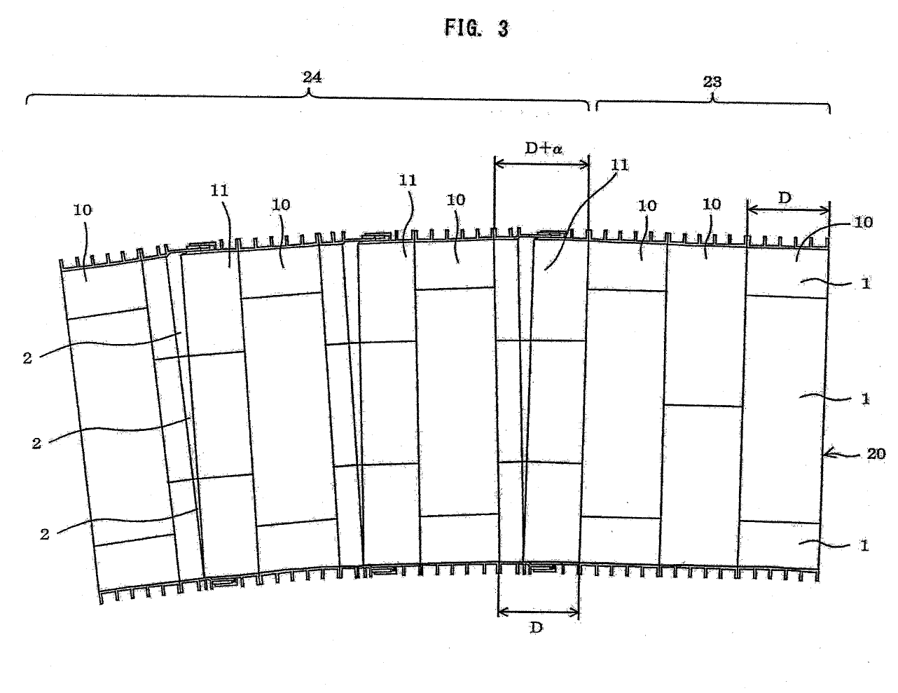

FIG. 3 shows the rehabilitation pipe 20 in cross-section. The rehabilitation pipe 20 includes a straight section 23 and an arc-shaped curved section 24 having a predetermined radius of curvature. The straight section 23 is constructed simply using the pipe units 10, while the curved section 24 is constructed by the pipe units 10 and the variable-width pipe units 11 that are alternately disposed. An Interval at which the variable-width pipe units are disposed is determined depending on the radius of curvature of the existing pipe 21 or the inside diameter thereof. The rehabilitation pipe 20 may be assembled simply using the variable-width pipe units 11 or by employing an arrangement in which two pipe units 10 are disposed between the variable-width pipe units 11.

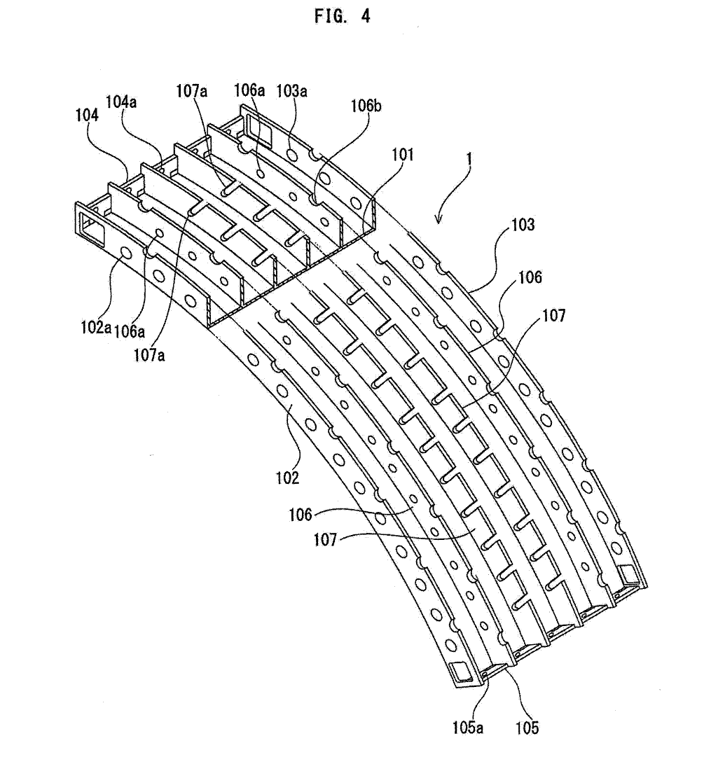

FIG. 4 shows the structure of a normal segment 1 having no variable-width function. The segment 1 is an integrally formed block-shaped member made from a plastic material, comprising an inner surface plate 101 constituting an inner circumferential surface of the rehabilitation pipe 20, side plates 102, 103 provided vertically upright on both sides extending in the circumferential direction of the inner surface plate 101, and end plates 104, 105 provided vertically upright on both ends extending in the pipe-length direction of the inner surface plate 101.

In the present embodiment, the segment 1 has a shape that is curved as an arc representing a predetermined angle that equally divides the circumference, e.g., a 72° arc that divides the circumference into fifths. However, the segment is not limited to that having an arc or a fan shape. The segment may be shaped as, e.g., a cuboid or a shape that is bent so as to have a curved right angle depending on the cross-section profile or the size of the existing pipe or the location of the existing pipe to be repaired.

A plurality of inner plates 106, 107 (two inner plates 106 and two inner plates 107 in the present embodiment) having a shape similar to that of the side plates are provided upright at equal intervals and parallel to the side plates 102, 103 on the upper surface of the inner surface plate 101 and on the inside relative to the side plates 102, 103 in order to reinforce the mechanical strength of the segment 1.

The inner surface plate 101, the side plates 102, 103, the end plates 104, 105, and the inner plates 106, 107 are all made from an identical transparent, semi-transparent or opaque plastic material, and are integrally formed using a known molding technique.

A plurality of holes 102a and 103a for admitting insertion of a metallic member for linking the segment 1 in the pipe-length direction are provided at equal intervals along the circumference in the side plates 102 and 103. The holes 102a in the side plate 102 and holes 103a in the side plate 103 are located at coinciding positions along the circumferential direction. Similarly, the inner plates 106 are provided with holes 106a and the inner plates 107 are provided with notches 107a.

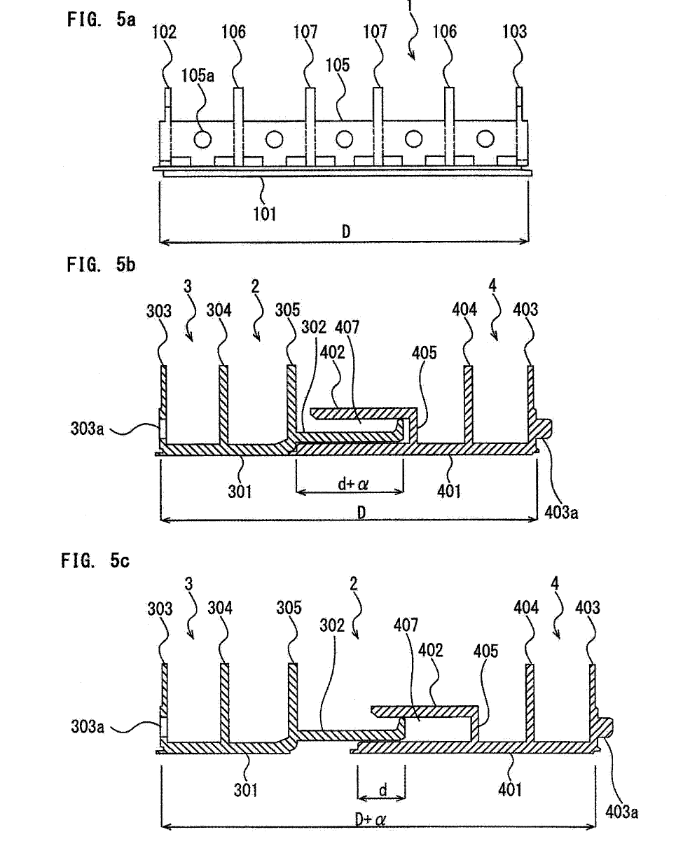

FIG. 5a is a detailed view of the end plate 105. The following descriptions are given in relation to the end plate 105, but the end plate 104 also has a configuration similar to that of the end plate 105.

The end plate 105 is a rectangular thin-plate member arranged between the side plate 102 and the side plate 103. The height of the end plate 105 from the outer surface of the inner surface plate 101 is slightly lower than that of the side plates 102, 103. Circular insertion holes 105a for admitting insertion of a bolt for linking the segment 1 in the circumferential direction are provided on the end plate 105 between the side plate 102 and an inner plate 106, between the inner plate 106 and an inner plate 107, between the two inner plates 107, between the inner plate 107 and an inner plate 106, and between the inner plate 106 and the side plate 103.

The variable-width segment 2 has a structure that is substantially similar to that of the segment 1, but is comprised of two segment halves so as to be variable in width in the pipe-length direction. FIG. 5b shows the variable-width segment 2 in cross-section along the pipe-length direction.

The variable-width segment 2 is composed of a segment half 3 and a segment half 4. The segment half 3 is configured from an inner surface plate 301, a convex plate 302, a side plate 303, inner plates 304, 305, and the like. The plates 301 to 305 are all integrally molded using the same plastic material as the segment 1. The convex plate 302 extends parallel to and at a different height from the inner surface plate 301. The side plate 303, and inner plates 304, 305 extend perpendicular to the inner surface plate 301.

The segment half 4 is configured from an inner surface plate 401, a side plate 403, inner plates 402, 404, 405, and the like. The plates 401 through 405 are all integrally molded using the same plastic material as the segment 1. The side plate 403 and the inner plates 404, 405 extend perpendicular to the inner surface plate 401, and the inner plate 402 extends parallel to the inner surface plate 401.

Formed in the side plate 403 is a protuberance 403a for fitting with the holes 102a, 103a in the side plates 102, 103 of the segment 1, or with the hole 303a in the segment half 3.

A concavity 407 for fitting with the convex plate 302 of the segment half 3 is formed by the inner plates 402, 405 and the inner surface plate 401.

The overlap of the convex plate 302 with the inner surface plate 401 in the concavity 407 is varied between d+a in FIG. 5b and d in FIG. 5c to vary the width of variable-width segment 2 in the pipe-length direction between D and D+α. Thus, each of the variable-width segments 2 can be varied in width to provide the pipe unit 11 whose width in the pipe-length direction gradually increases toward the outside of the curve from the inside thereof, as shown in FIG. 3.

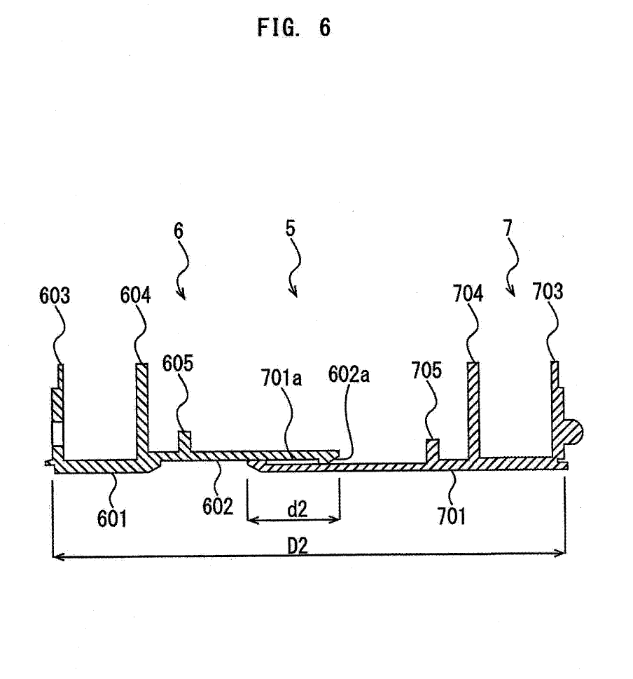

FIG. 6 shows another embodiment of a variable-width segment. The variable-width segments are integrated and fixed in place by the filler injected between the existing pipe and the rehabilitating pipe. Therefore, the segment halves 3, 4 do not necessarily need to be fitted and linked together as shown in FIGS. 5a and 5b. Segment halves can also be superposed so as to constitute a variable-width segment as shown in FIG. 6.

In FIG. 6, the segment half 6 is configured from an inner surface plate 601, a convex plate 602, a side plate 603, inner plates 604, 605, and the like. The plates 601 to 605 are all integrally molded using the same plastic material as the segment 1. The convex plate 602 extends parallel to and at a different height from the inner surface plate 601. The side plate 603, and inner plates 604, 605 extend perpendicular to the inner surface plate 601.

The segment half 7 is configured from an inner surface plate 701, a side plate 703, inner plates 704, 705, and the like. The plates 701 through 705 are all integrally molded using the same plastic material as the segment 1. The side plate 703 and the inner plates 704, 705 extend perpendicular to the inner surface plate 701.

The segment halves 6, 7 configured in this manner are moved so that the convex plate 602 of the segment half 6 and the inner surface plate 701 of the segment half 7 are made to overlap by sliding the ridge 602a of the convex plate 602 through the concavity 701a of the segment half 7. In other words, the overlap width d2 in FIG. 6 is made variable to make the width D2 of the segment 5 variable.

Since the segment halves 6, 7 are merely superposed together, they are likely to move in the radial direction and separate. Therefore, after the positions in the segment width direction are adjusted, the segment halves 6, 7 are preferably temporarily bonded or temporarily joined in a superposed state. When the existing pipe and the rehabilitating pipe are integrated by the filler injected between the two, the segment halves 6, 7 can no longer move, and accordingly there is no danger of the segment halves moving in the radial direction.

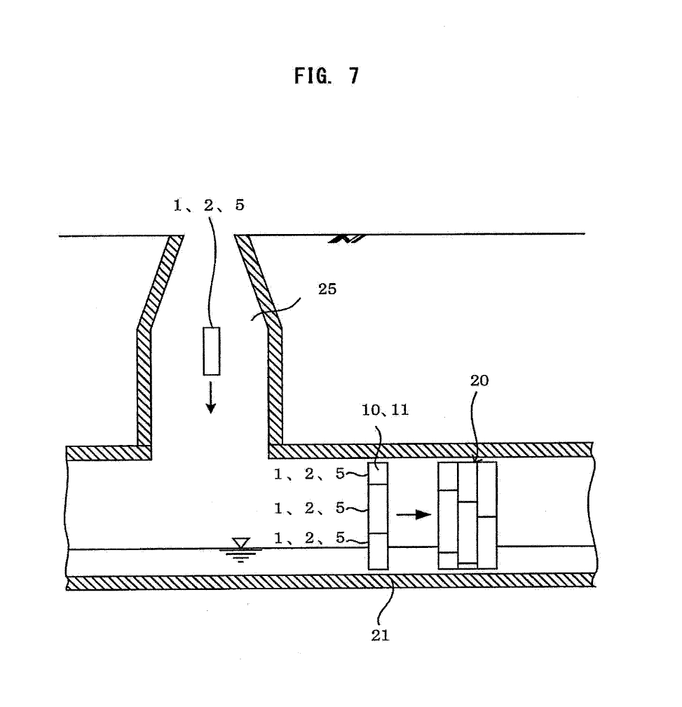

A description will now be given for a method for rehabilitating an existing pipe using the segments 1 and the variable-width segments 2, 5 configured as described above. First, as shown in FIG. 7, the segments 1 and the variable-width segments 2, 5 are carried through a manhole 25 into an existing pipe 21, and the segments 1, 2, 5 are sequentially linked in the circumferential direction to assemble the pipe unit 10 and the variable-width pipe unit 11.

Next, the pipe units 10 and the variable-width pipe units 11 are sequentially linked in the pipe-length direction to construct the rehabilitation pipe 20 inside the existing pipe 21.

If the diameter of the rehabilitation pipe is large, the segments 1 and the variable-width segments 2, 5 that have been carried in can be transported to the location of actual installation, and the segments 1, 2, 5 are linked in the circumferential direction and in the pipe-length direction at this location.

Next, a filler such as grout is injected into a space 22 (see FIG. 1) between the rehabilitation pipe 20 and the existing pipe 21, and the filler is hardened. Both end sections of the space 22 are blocked using a resin pate, mortar, or another sealing agent. For injection of the filler, an injection hole is formed in, e.g., the inner surface plate 101, and the filler is injected therefrom. Injection is performed until the filler has reached the entirety of the rehabilitation pipe and has started to flow out from the side plates 102 of the segments 1, 2, 5 on both ends in the pipe-length direction.

The injected filler allows the existing pipe 21 and the rehabilitation pipe 20 to be solidly bound to create a composite pipe comprising the existing pipe, the filler, and the rehabilitation pipe.

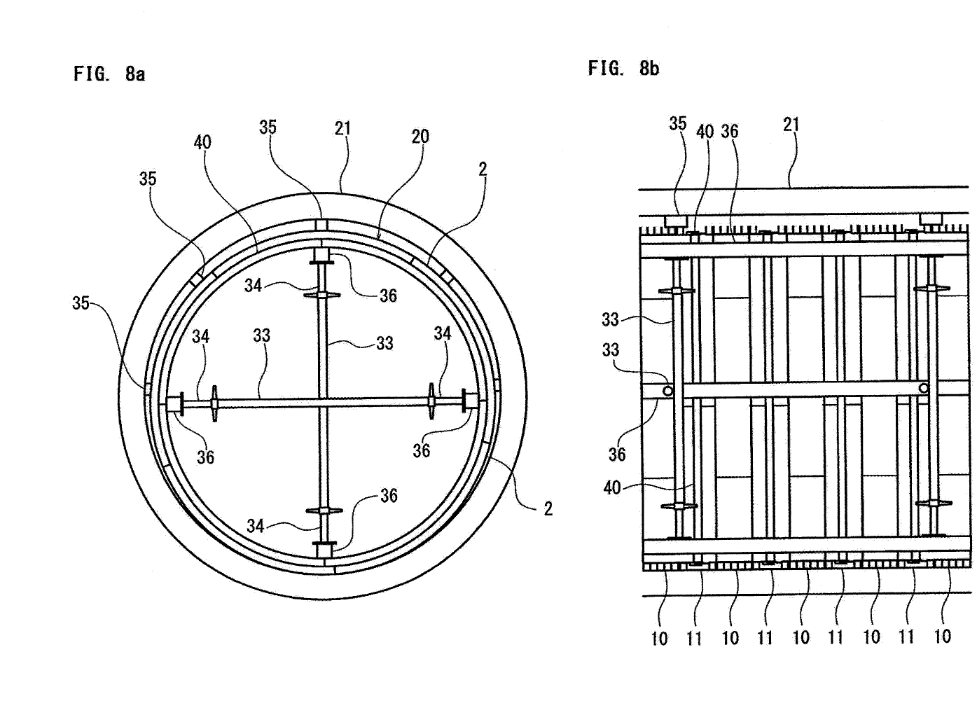

FIGS. 8a and 8b show a falsework for temporarily supporting the rehabilitation pipe 20 until the filler is hardened. The rehabilitation pipe 20 is installed with its center deviating downwards relative to the center of the existing pipe 21. Therefore, a spacer 35 is inserted into sections of a large gap between the tip of the side plates 102 (outer circumference surface of the rehabilitation pipe 20) and the inner circumference surface of the existing pipe 21 in order to resist against buoyancy of the filler and maintain a positional relationship of the rehabilitation pipe 20 relative to the existing pipe 21.

An annular shape-holding member 40 is disposed over the entire circumference of the rehabilitation pipe 20 at locations at which the variable-width pipe units 11 are disposed. The shape-holding member 40 is divided into four pieces in the circumferential direction considering workability, and is fabricated so as to fit to the shape of the inner surface of the rehabilitation pipe 20 by bending shape steel such as a square pipe steel. The shape-holding member 40 doesn't necessarily need to be disposed over the entire circumference of the rehabilitation pipe, and may be disposed merely at locations at which the filler is likely to leak depending on the cross-sectional shape of the rehabilitation pipe 20.

A wale 36 is disposed in the pipe-length direction so as to come into contact with the inner surface of the shape-holding member 40. Two pairs of wales 46, i.e., four wales in total are disposed at locations symmetrical relative to the cross-sectional center of the rehabilitation pipe 20. Each pair of wales 46 are supported by a support member 33 made of a pipe or a rod member. The support member 33 indirectly supports the shape-holding member 40 via the wale 36. A jack base 34 is connected to both ends of the support member 33 to adjust the length thereof in the radial direction. A method for supporting the shape-holding member 40 is not limited to the example as shown in FIGS. 8a and 8b, but may be modified depending on the cross-sectional shape or the diameter of the rehabilitation pipe 20. For example, in cases where the rehabilitation pipe 20 is comprised only of the variable-width segment 2, a space adjuster (not shown) may be inserted between the shape-holding member 40 and the wale 36 in order to support a plurality of shape-holding members 40 together by the wale 36.

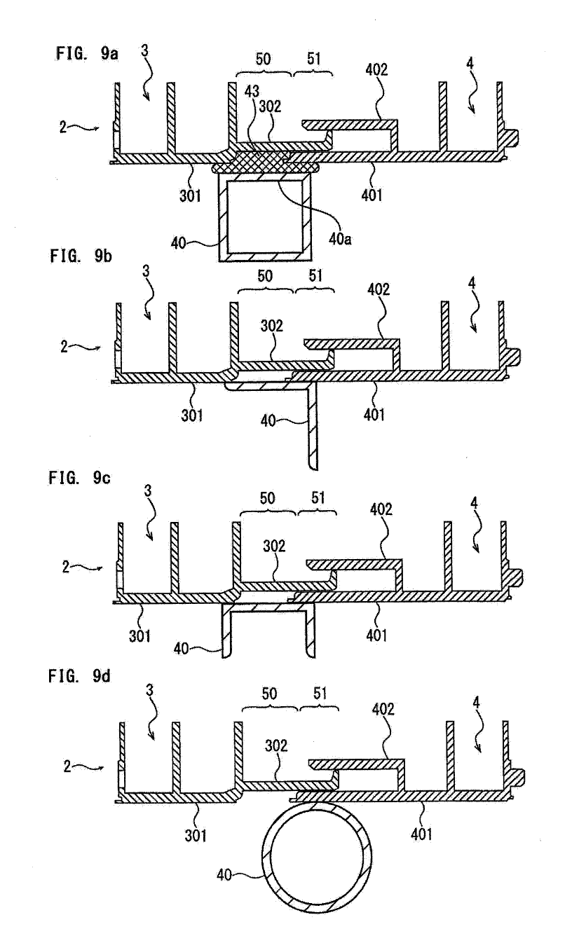

FIG. 9a shows in detail a section at which the shape-holding member 40 comes into contact with the variable-width segment 2 via a cushion 43 or without any cushion.

In the following, the example of no cushion will be described. The shape-holding member 40 is a square pipe in cross-section comprising four integrated plates, one of which 40a is in contact with the inner surface plate of the variable-width segment 2, i.e., the inner surface plate 301 of the segment half 3 and the inner surface plate 401 of the segment half 4. The shape-holding member 40 is disposed in the pipe-length direction so as to come into contact with a section at which the segment half 3 overlaps with the segment half 4 (hereinafter, referred to as an overlap section), for example, a section indicated by the numerical symbol 51 in FIG. 9a at which the convex plate 302 of the segment half 3 overlaps with the inner surface plate 401 of the segment half 4, or at locations near the overlap section at which the shape-holding member 40 comes into contact with the inside plate of the overlap section, i.e., the inner surface plate 401 in FIG. 9a. This allows force to be applied to press the member existing inside in the radial direction against the member existing outside (the convex plate 302 in FIG. 9a). In order to ensure such a function, it may be preferable to bring the shape-holding member 40 into contact with the overlap section in part or all.

As shown by the numerical symbol 50 in FIG. 9a, there is a section at which the filler leaks such as a section between the right end of the inner surface plate 301 and the left end of the inner surface plate 401, in other words, a section at which the convex plate 302 doesn't overlap with the inner surface plate 401 (hereinafter, referred to as a gap section). If the shape-holding member 40 is disposed at such a gap section 50 so as to cover the whole thereof, the exit from which the filler leaks would be plugged, thereby suppressing the leak of the filler, even if pressing force acting from the inner surface plate 401 to the convex plate 302 is insufficient. Disposing the cushion 43 that plugs the gap section 50 ensures that the filler is less likely to leak out. The cushion 43 is a plate member, which is preferably made from a soft material such as synthetic rubber so as to be adaptive for the variation of the gap section 50.

The shape-holding member 40 may be L-shaped in cross-section, as shown in FIG. 9b, or in the shape of a groove, as shown in FIG. 9c. Such a modified shape-holding member 40 may also be disposed such that one plate constituting the shape-holding member 40 comes into surface contact with one of the inner surface plates 301, 401, at least with the inner surface plate 401. The modified shape-holding member 40 may also be disposed in the pipe-length direction at locations similar to those for the square pipe in cross-section, as shown in FIG. 9a.

The shape-holding member 40 may also be circular in cross-section, as shown in FIG. 9d. Such a modified shape-holding member 40 comes into line contact with the variable-width segment 2, so that it is disposed at the location at which the shape-holding member 40 contacts the overlap section 51, as shown in FIG. 9d.

According to the present embodiment, the shape-holding member 40 is disposed so as to come into contact with at least the inner surface plate 401 (701) of the segment halves 3, 4 (6, 7), so that the inner surface plate 401 (701) is pressed against the convex plate 302 (602). Therefore, the inner surface plate 401 (701) and the convex plate 302 (602) come into close contact with each other with the gap between both the plates being reduced, allowing the filler to be less likely to leak. The shape-holding member 40 is ring-shaped, so that it comes into contact with the entire inner circumferential surface of the variable-width pipe unit 11, and the above-mentioned advantages are obtained all over the circumference thereof.

The location at which the shape-holding member 40 is disposed is not limited to the overlap section 51 of the inner surface plate 401 (701), but bringing the shape-holding member 40 into contact with the overlap section 51 ensures that the inner surface plate 401 (701) is pressed against the convex plate 302 (602).

In cases where the shape-holding member 40 is disposed so as to plug the gap section 50, the possible exit from which the filler leaks can be plugged, ensuring that the filler is prevented from leaking.

The shape-holding member 40 also holds the cross-sectional shape of the rehabilitation pipe 20. This enhances the function of the spacer 35 that is inserted between the existing pipe 21 and the rehabilitation pipe 20. In particular, in cases where the rehabilitation pipe is rectangular and non-circular in cross-section, the function of the spacer 35 is enhanced, allowing the spacer to be prevented from positional deviation.

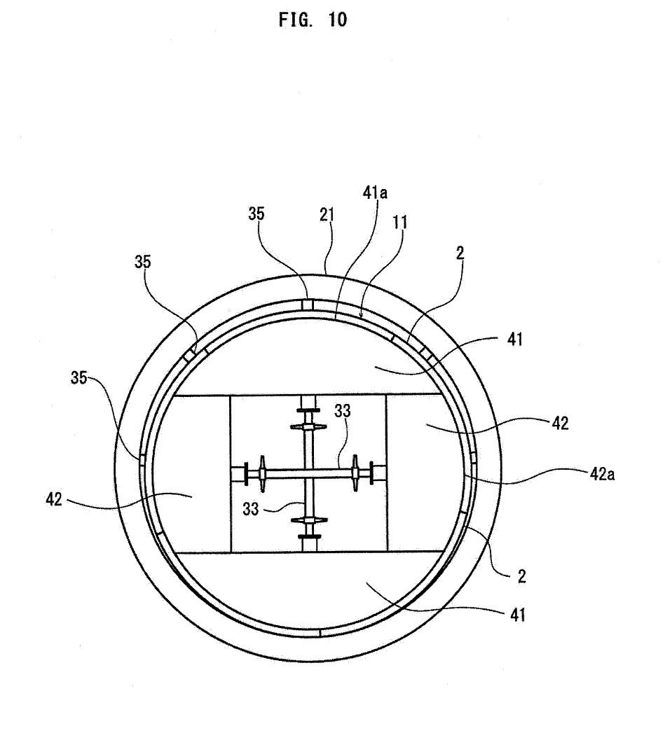

The shape-holding member 40 may be shaped other than ring-shaped. FIG. 10 shows a shape-holding member comprising two plate members 41 and two plate members 42. The plate member 41 is arcuate and is disposed so as to come into contact at its arc-shaped end 41a with the inner surface of the rehabilitation pipe 20. The plate member 42 has an arc shape with both ends cut off, and is disposed so as to come into contact at its arc-shaped end 42a with a section at which the plate member 41 doesn't contact the inner surface of the rehabilitation pipe 20. In other words, the entire circumference of the inner surface plate of the variable-width pipe unit 11 is pressed by the arc-shaped ends 41a, 42a of the four plate members 41, 42. Similarly to the embodiment in FIG. 8, the two facing plate members 41, 42 are supported so as to be tensioned by the support member 33. The preferable location at which the plate members 41, 42 are disposed in the pipe-length direction is similar to that described in connection with the annular shape-holding member 40 in FIG. 9. The effects obtained are also similar to those of the annular shape-holding member 40.

A description was given for the embodiment in which the variable-width segment is used to adapt to the bend of the existing pipe. Another embodiment will be described in which the variable-width segment is used to provide a rehabilitation pipe with enhanced earthquake resistance. The structure of the rehabilitation pipe is substantially the same as that in the above-mentioned embodiment, so that components identical to those in the above-mentioned embodiment are denoted by the same numerical symbols and are not described in detail.

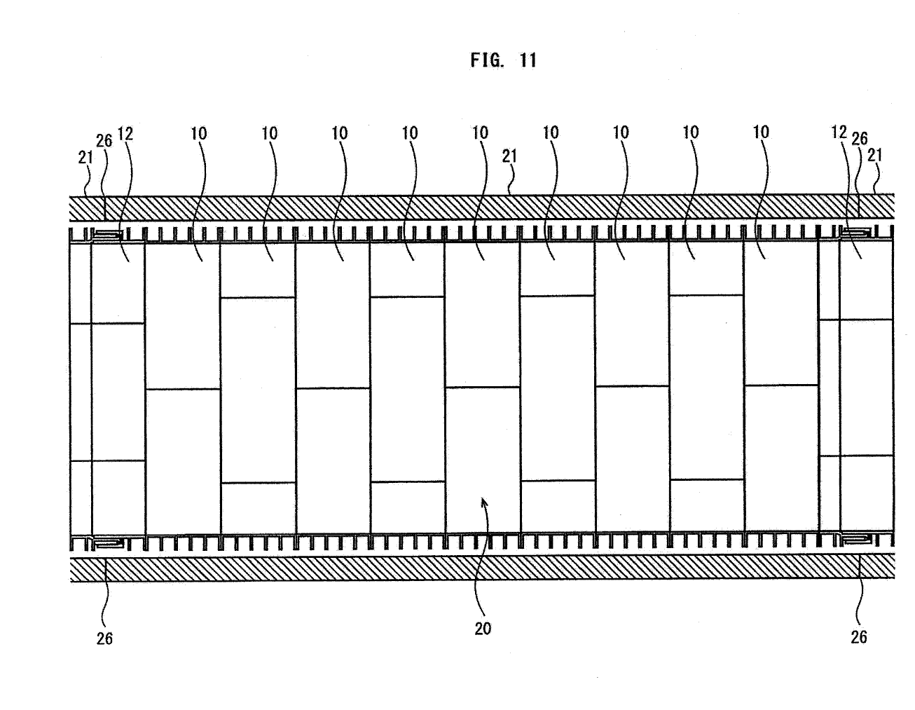

FIG. 11 shows the rehabilitation pipe 20 in cross-section. The existing pipe 21 extends straight, so that the rehabilitation pipe 20 is assembled mainly using the normal pipe units 10. However, in order to enhance earthquake resistance, a variable-width pipe unit 12 is employed at the section of seams 26 of the existing pipe 21.

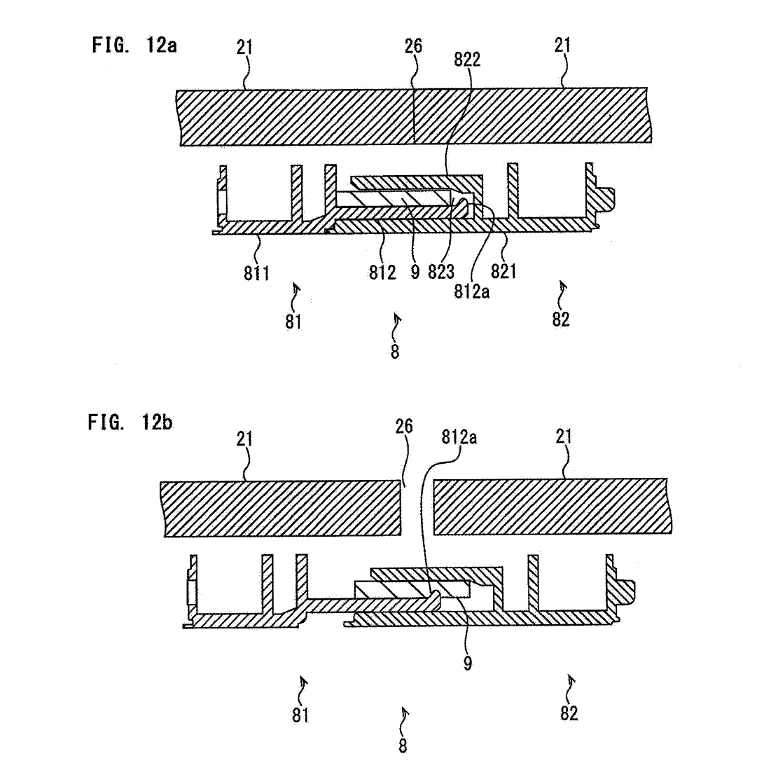

FIG. 12a shows in cross-section a variable-width segment 8 constituting the variable-width pipe unit 12. The variable-width segment 8 has an arrangement similar to that of the variable-width segment 2 in FIG. 5b and comprises two segment halves 81, 82 having inner surface plates 811, 821, which are moved relative to each other in the pipe-length direction to make the width thereof in the pipe-length direction variable. The segment half 81 and the segment half 82 are disposed so that the inner surface plate 811 and the inner surface plate 821 are coplanar. A convex plate 812 is inserted into a concavity 823 formed by the inner surface plate 821 and an inner plate 822. Inserted between the convex plate 812 in the concavity 823 and the inner plate 822 is a braking member 9 that is made from an elastic planar plate material such as synthetic rubber or plastics. The braking member 9 is disposed all over the circumference of the variable-width segment 8.

A great amount of tension acts on the existing pipe 21 when an earthquake occurs, and the seams 26 thereof separate. In such a case, the segment halves 81, 82 are moved to each other in the pipe-length direction so as to separate, enlarging the width of the variable-width segment 8, as shown in FIG. 12b. At this time a ridge 812a provided at the tip of the convex plate 812 digs into the braking member 9 to brake the separation of the segment halves 81, 82. If the tension is greater than this braking force, the segment halves 81, 82 move relative to each other depending on the amount by which the seams 26 separate. However, as long as the ridge 812a and the braking member 9 remains in contact with each other, liquefied sand or the like can be prevented from flowing into the rehabilitating pipe 20.

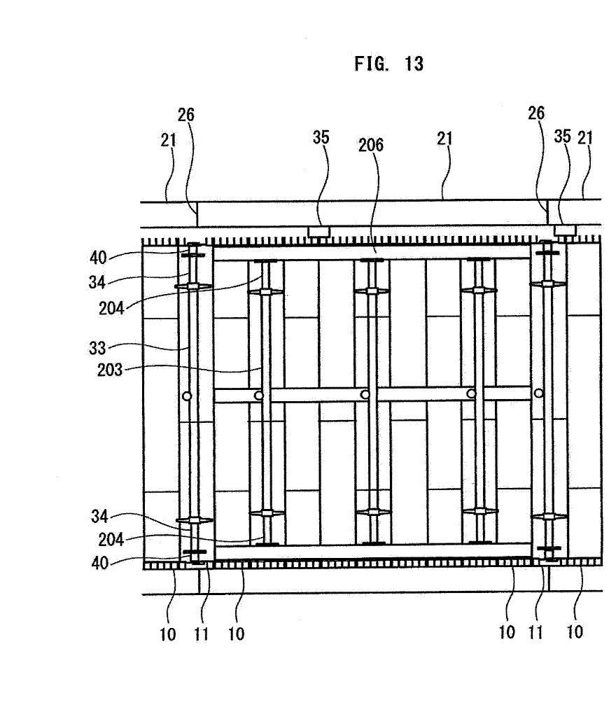

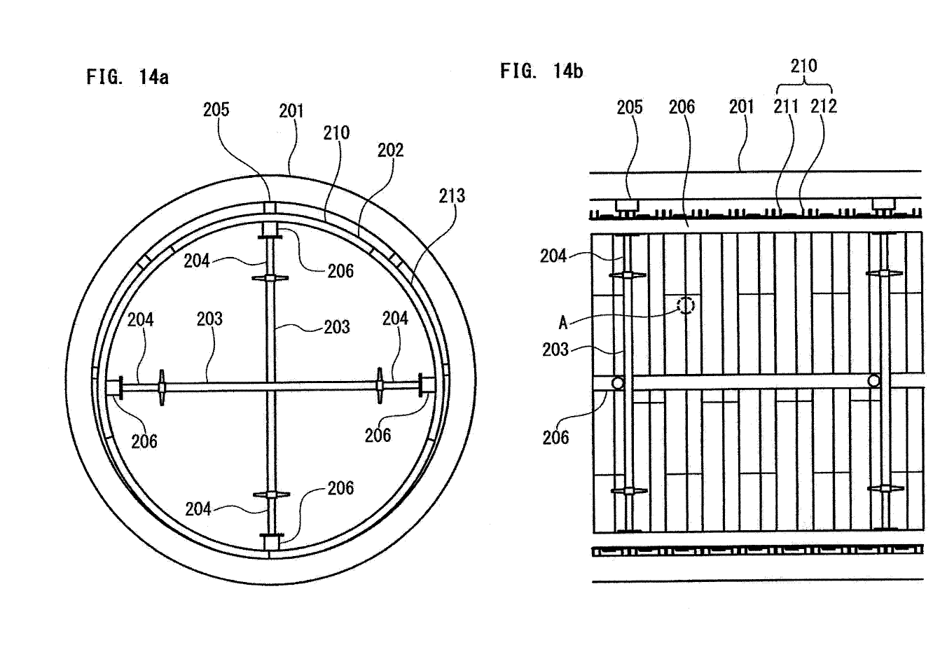

FIG. 13 shows the structure of a falsework used in constructing the rehabilitation pipe as shown in FIG. 11. For the sections other than the seams 26 of the existing pipe 21 at which the pipe unit 10 is disposed, a wale 206 is disposed in the pipe-length direction inside the rehabilitation pipe as in the conventional falsework shown in FIGS. 14a and 14b. The wale 206 is then supported by a support member 203 with the jack bases 34 connected at both ends thereto. For the seam sections 26 of the existing pipe 21 at which the variable-width pipe unit 12 is disposed, the shape-holding member 40 is disposed so as to be in contact with the inner surface of the rehabilitation pipe 20. In this case, the shape-holding member 40 is supported directly by the support member 33 with the jack bases 34 connected at both ends without disposing any wale inside the shape-holding member 40. In FIG. 13, the support member 203 is disposed at three locations, and the number thereof may depend on the load acting on the wale.

This embodiment also provides the effect similar to that of the previous embodiment. In other words, the shape-holding member 40 presses the inner surface plate 821 against the convex plate 812, which is pressed against the braking member 9, which is then pressed against the inner plate 822. Therefore, the inner surface plate 821 and the convex plate 812; the convex plate 812 and the braking member 9; and the braking member 9 and the inner plate 822 are brought into close contact with each other, thus allowing the filler to be prevented from leaking.

What is claimed is:

1. An apparatus for supporting a rehabilitation pipe inside an existing pipe since a filler is injected into a space between the rehabilitation pipe and the existing pipe until the filler hardens, wherein the rehabilitation pipe is assembled using integrally formed plastic segments each comprising an inner surface plate, and side and end plates provided upright on a peripheral edge of the inner surface plate, the segments being in part or all divided in the pipe-length direction to provide a variable-width segment comprising two segment halves that are moved relative to each other in the pipe-length direction to make the width of the segment in the pipe-length direction variable, the apparatus comprising:
a shape-holing member that is disposed circumferentially in part or all over the inner surface of the rehabilitation pipe so as to be in contact with the inner surface plate of the variable-width segment; and
a support member for directly or indirectly supporting the shape-holding member.

2. An apparatus for supporting a rehabilitation pipe according to claim 1, wherein the variable-width segment includes an overlap section at which the segment halves overlap in the radial direction, and the shape-holding member comes into contact at the overlap section with the inner surface plate of the segment half that exists inside in the radial direction.

3. An apparatus for supporting a rehabilitation pipe according to claim 1, wherein the shape-holding member is disposed so as to plug an exit at the junction of the two segment halves from which the filler is likely to leak.

4. An apparatus for supporting a rehabilitation pipe according to claim 1, wherein the shape-holding member is a ring-shaped member that is disposed over the entire inner circumferential surface of the rehabilitation pipe.

5. An apparatus for supporting a rehabilitation pipe according to claim 1, wherein a cushion is provided to plug an exit at the junction of the two segment halves from which the filler is likely to leak.

6. A method for supporting a rehabilitation pipe inside an existing pipe since a filler is injected into a space between the rehabilitation pipe and the existing pipe until the filler hardens, wherein the rehabilitation pipe is assembled using integrally formed plastic segments each comprising an inner surface plate, and side and end plates provided upright on a peripheral edge of the inner surface plate, the segments being in part or all divided in the pipe-length direction to provide a variable-width segment comprising two segment halves that are moved relative to each other in the pipe-length direction to make the width of the segment in the pipe-length direction variable, the method comprising:
disposing a shape-holing member circumferentially in part or all over the inner surface of the rehabilitation pipe so as to be in contact with the inner surface plate of the variable-width segment; and
directly or indirectly supporting the shape-holding member using a support member.

7. A method for supporting a rehabilitation pipe according to claim 6, wherein the variable-width segment includes an overlap section at which the segment halves overlap in the radial direction, and the shape-holding member comes into contact at the overlap section with the inner surface plate of the segment half that exists inside in the radial direction.

8. A method for supporting a rehabilitation pipe according to claim 6, wherein the shape-holding member is disposed so as to plug an exit at the junction of the two segment halves from which the filler is likely to leak.

9. A method for supporting a rehabilitation pipe according to claim 6, wherein the shape-holding member is a ring-shaped member that is disposed over the entire inner circumferential surface of the rehabilitation pipe.

10. A method for supporting a rehabilitation pipe according to claim 6, wherein a cushion is provided to plug an exit at the junction of the two segment halves from which the filler is likely to leak.
